(19) United States
(12) Patent Application Publication
(10) Pub. No.: US 2024/0422582 A1
(43) Pub. Date: Dec. 19, 2024

(54) ENHANCEMENTS FOR ROBUST MULTI-STATION COMMUNICATION IN REMOTE ENVIRONMENTS

(71) Applicants: James L. Gilbert, Lenexa, TX (US); Nicholas T. Agnew, Lenexa, TX (US); Auston W. Jacobsen, Lenexa, TX (US)

(72) Inventors: James L. Gilbert, Lenexa, TX (US); Nicholas T. Agnew, Lenexa, TX (US); Auston W. Jacobsen, Lenexa, TX (US)

(21) Appl. No.: 18/670,239

(22) Filed: May 21, 2024

Related U.S. Application Data
(63) Continuation-in-part of application No. 18/257,970, filed on Jun. 16, 2023.

(51) Int. Cl. H04W 24/02; H04W 84/18; H04W 88/08

(52) U.S. Cl. CPC H04W 24/02; H04W 84/18; H04W 88/08

(57) ABSTRACT

This Continuation-in-Part (CIP) application builds upon a rapidly deployable communication system designed for remote and logistically challenging environments. It introduces advancements in establishing robust communication within a multi-station network, addressing limitations like limited connectivity options and network management complexity. The CIP explores solutions to ensure uninterrupted communication and simplifies deployment processes, ultimately resulting in a more resilient, adaptable, and user-friendly communication system ideal for harsh and demanding remote settings.

### CROSS-REFERENCE TO RELATED APPLICATIONS

This application claims priority to the PCT application titled ‘Remote communications system and method,’ with U.S. Non-provisional application Ser. No. 18/257,970, which in turn claims priority to U.S. Provisional Patent Application No. 63/127,500, filed on Dec. 18, 2020. The entirety of both applications is incorporated herein by reference.

This Continuation-in-Part (CIP) application builds upon the foundation laid in the parent application, focusing on enhancing functionalities and configurations for establishing robust communication within a multi-station network, particularly in remote and logistically challenging environments. The original disclosure addressed key limitations by offering a rapidly deployable communication system with functionalities like simplified deployment, portability, scalability, and increased user capacity.

This CIP expands on this foundation by exploring advancements designed to overcome the unique challenges associated with multi-station communication in remote settings:

Limited Connectivity Options: Traditional wired connections might be impractical. This CIP explores solutions to ensure efficient and reliable wireless communication between base stations and distribution modules.

Signal Degradation: Long distances and potential obstacles can weaken signal strength. Advancements in this CIP address maintaining robust network connectivity across geographically dispersed stations.

Network Management Complexity: As the number of stations increases, managing connections becomes intricate. This CIP focuses on functionalities to optimize data flow and ensure seamless communication within the multi-station network.

Solution Offered by this CIP:

By focusing on these advancements, this CIP addresses the challenges of multi-station communication in remote environments. It explores the technical details of these improvements, showcasing how they contribute to establishing a communication system that is:

Resilient: Overcomes limitations of remote connectivity and signal degradation.

Adaptable: Manages complex network configurations efficiently.

User-Friendly: Simplifies deployment and streamlines network operation.

This CIP ultimately aims to solidify the advantages of the multi-station architecture and offer a comprehensive solution for reliable and scalable communication in diverse remote settings.

### Key Points:

The introduction highlights the focus on multi-station communication challenges in remote environments.

It connects these challenges to functionalities and advancements.

It establishes the solution offered by the CIP: a more robust, adaptable, and user-friendly system for remote communication.

### BRIEF DESCRIPTION OF THE DRAWINGS

FIG. 1 shows a wireless mesh communication system configuration for two classes, according to some embodiments of the present disclosure. A central base station connects to distribution modules, forming a network. The network can be configured in two ways: Class 1 with a single distribution module directly connected to the base station, or Class 2 with multiple distribution modules interconnected, forming a mesh network. Communication of said system is understood to be bi-directional by those skilled in the art.

FIG. 2 depicts a wireless mesh communication system configuration for Class 3, according to some embodiments of the present disclosure. It builds upon the concepts introduced in FIG. 1 and incorporates additional elements to establish a more complex network architecture. Specific details of these additional elements and their functionalities are not shown here but will be described in detail elsewhere in the present disclosure.

### DETAILED DESCRIPTION OF THE DRAWINGS

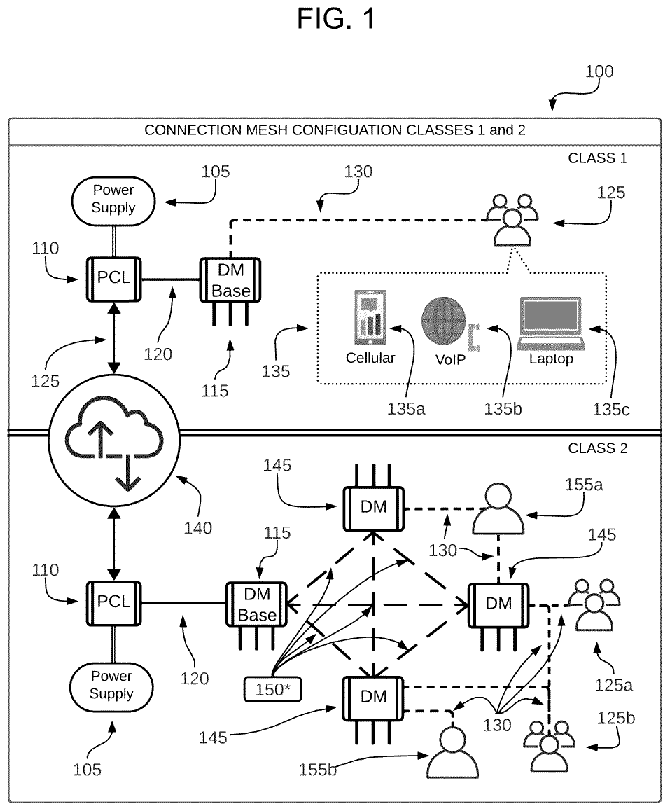

FIG. 1 depicts a wireless mesh communication system configuration for two distinct classes, according to some embodiments of the present disclosure. For class 1 (top), the system comprises a central base station and one distribution modules, according to some embodiments of the present disclosure, working together to establish a communication network.

Class 1 Configuration: In Class 1 (represented by the connection between the base station (110) and Base DM (115)), a single distribution module connects directly to the central base station. This configuration might be suitable for smaller deployments or areas with less complex communication requirements. The Base DM is connected to the PCL to form this network through a PoE connection (120) and is capable to support upwards of 250 unique wireless connections for end users.

This simpler network is operated by a single power supply (105) and is connected to an external internet source (140).

End users (125) are connected to the Base DM via a wireless network connection (130), and representative supported devices connected in this embodiment are cellular phones (135a), VoIP devices (135b), and laptop computers (135c).

Class 2 Configuration: In Class 2 (represented by the interconnection of multiple DMs: 115 and 145), multiple distribution modules are interconnected, forming a mesh network. This mesh network requires at least one Base DM and additional remote DMs. This configuration offers much greater flexibility and scalability, also extending coverage to wider areas while accommodating a much larger number of connected devices.

Central Base Station (110): The figure shows a central base station, labeled “PCL” (110), which serves as the core hub of the communication system. According to some embodiments, this base station might house the primary communication processing unit, responsible for routing and managing data flow within the network.

Distribution Modules (DMs) (115, 145): Multiple distribution modules (DMs), labeled “DM” (115, 145), are interconnected with the base station. These modules are responsible for distributing the communication signal throughout the network, relaying signals between different network locations and extending the overall coverage area.

Data flows between the base station and distribution modules, between interconnected distribution modules, between the end-user devices (135a, 135b, 135c), and ultimately between the presently disclosed invention and the external internet (140).

In the case of the Class 2 configuration, a network mesh is shown (150*). It shares the requisite power and external internet source. It is to be understood that for the case of the end users—either single users (155a,b) or multiple users (155a,b)—similar devices are also connected to the network. In Class 2, a richer network connection is possible, as shown by 155a—a single user connected to multiple DMs simultaneously—and 155b—a single user connected to only one DM. This is also shown for the case of multiple users—where connections are supported for single DM-networks as well as multiple DM connected networks depicted by 125a, and 125b, respectively.

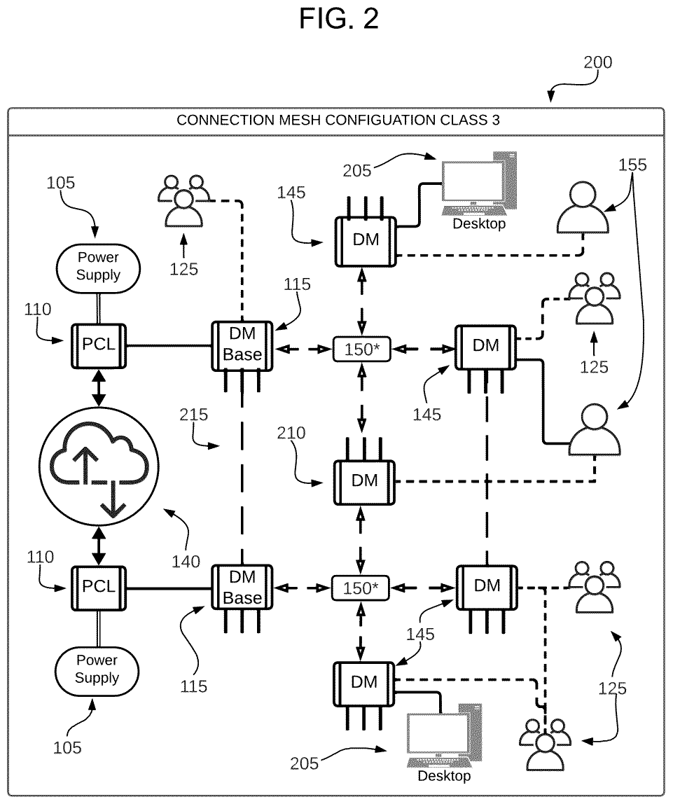

FIG. 2 illustrates a wireless mesh communication system configuration for Class 3, according to some embodiments of the present disclosure. This configuration builds upon the concepts introduced in Class 1 and Class 2 (refer to FIG. 1 for details on those classes).

### Central Base Station (110):

The figure depicts two distinct PCL units (110) serving as the core of the communication system. Similar to Class 1 and Class 2, these units function as the central hub, facilitating communication within the network.

The system is powered by one or more power supplies, (105), according to some embodiments of the present disclosure. These power supplies ensure the base station and base DMs have the necessary power to function.

### External Internet Source (140):

The figure shows an external internet source (140) connected to the system. This connection allows the network to access the broader internet, enabling communication beyond the local network itself, according to some embodiments of the present disclosure.

### Distribution Modules (DM) (115, 145, 210):

Multiple distribution modules (DMs), labeled “DM” (115, 145, 210), are interconnected with the central base station (110). These modules, each containing a wireless communication device, work together to distribute and relay communication signals throughout the network, extending the overall coverage area. Each sub-network requires at least one base DM to operate, and in the case of the upper portion of the figure, two base stations are shown. It is to be understood for all DMs not in direct connection to a PCL, distinct low-voltage DC power sources are required for operation.

### Desktop (Desktop):

The figure depicts a desktop computer connected to a DM (205) by a cable. It is to be understood that the general direction of communication within the system is bi-directional between all various connected elements:

The base station (110) and the DMs (115, 145, 210).

Interconnected DMs, enabling communication to relay across the network through a mesh structure.

It is understood that end-user devices, like the desktop computer shown, are potentially connected to the DMs in (200).

While FIG. 2 depicts a specific configuration with a desktop computer connected to a DM, the details of Class 3 encompass a wider range of possibilities in the embodiments. These variations involve:

The communication protocols used by the devices within the network.

The specific interconnection patterns between the base station and DMs, potentially creating more complex mesh network structures with a higher number of connected devices.

The system offers flexibility in configuration based on deployment needs and supports a broader range of devices compared to simpler Classes 1 and 2 (100).

Class 3 illustrates a variety of connection types. It to be understood that this could involve end users connecting to one or more DM units either through a single device connected to multiple DMs on the same network or multiple devices connected to multiple mesh network components.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A rapidly deployable communications system, designed for rugged outdoor deployments, comprising:
A first portable communication link (PCL), configured for easy transport and deployment in remote locations, comprising:
A first network module comprising:
A cellular backhaul with a cellular modem for communication with a cellular network, providing a primary internet source.
A first plurality of inlet/outlet ports, each having connectors configured to be unique and prevent incorrect assembly.
A first distribution module (DM), containing a first wireless communication device.

2. A rapidly deployable communications system, designed for rugged outdoor deployments, comprising:
The elements of claim 1.
A second distribution module (DM), including a second wireless communication device, wherein the second distribution module is configured for wireless communication with the first portable communication link (PCL) using their respective wireless communication devices.

3. A rapidly deployable communications system, designed for rugged outdoor deployments, comprising:
A first portable communication link (PCL1), configured for easy transport and deployment in remote locations, comprising the elements defined in claim 1.
At least one additional distribution module (DM), each including an additional wireless communication device.
A second portable communication link (PCL2), configured for easy transport and deployment in remote locations, comprising a second network module with a second plurality of inlet/outlet ports, each having connectors configured to be unique and prevent incorrect assembly.
At least one additional distribution module (DM), each including an additional wireless communication device.
*wherein the at least one additional distribution module associated with PCL1 and the at least one additional distribution module associated with PCL2 are configured for wireless communication with their respective portable communication links (PCLs) using their corresponding wired or wireless communication devices.

4. The rapidly deployable communications system according to claim 1, wherein:
The first wireless communication device comprises a first Wi-Fi access point implementing a first wireless communication standard, selectable from a group of standards including IEEE 802.11ax and upcoming standards such as IEEE 802.11ay.
The second wireless communication device comprises a second Wi-Fi access point implementing a second wireless communication standard, selectable from the same group of standards including IEEE 802.11ax and upcoming standards such as IEEE 802.11ay.
The additional wireless communication device comprises an additional Wi-Fi access point implementing a third wireless communication standard, selectable from the same group of standards including IEEE 802.11ax and upcoming standards such as IEEE 802.11ay.
The second base station is coupled in wireless communication with the one or more additional distribution modules and the first base station via Wi-Fi meshing established between the first, second, and additional Wi-Fi access points implementing their respective wireless communication standards.

5. The rapidly deployable communications system according to claim 1, wherein:
The first, second, and additional wireless communication devices each comprise a Wi-Fi access point implementing a predetermined wireless communication standard, specifically the IEEE 802.11ax standard.
The second base station is coupled in wireless communication with the one or more additional distribution modules and the first base station via Wi-Fi meshing established between the first, second, and additional Wi-Fi access points, all operating on the predetermined IEEE 802.11ax standard.

6. The rapidly deployable communications system according to claim 1, wherein:
The first, second, and additional wireless communication devices each comprise a Wi-Fi access point implementing a single, pre-determined wireless communication standard.
The second base station is coupled in wireless communication with the one or more additional distribution modules and the first base station via Wi-Fi meshing established between the first, second, and additional Wi-Fi access points, all operating on the same single, pre-determined wireless communication standard.

7. The rapidly deployable communications system according to claim 1, wherein:
The first wireless communication device comprises a first five gigahertz (5 GHz) radio providing up to a five kilometer (5 km) connection range.
The second and additional wireless communication devices each comprise a second 5 GHz radio providing up to a five kilometer (5 km) connection range.
The first base station (PCL) is coupled in wireless communication with the one or more additional distribution modules via the first 5 GHz radio on the first base station (PCL) and the second 5 GHz radios on the second and additional distribution modules.

8. The rapidly deployable communications system according to claim 1, wherein:
The first network module is configured to provide failover service between a first internet source, provided by the cellular backhaul with a cellular modem, and at least one additional internet source selected from a group including:
Satellite internet
Fiber optic internet
Ethernet internet connection
A secondary cellular internet connection.
At least one of the first plurality of inlet/outlet ports is configured for coupling in communication with the at least one additional internet source.

9. The rapidly deployable communications system according to claim 1, further comprising:
At least one power module configured to provide electrical power to one or more base stations.

10. The rapidly deployable communications system according to claim 1, comprising:
A base station comprising:
A first distribution module coupled thereto, the first distribution module comprising a first wireless communication device.
A network module comprising:
A cellular backhaul comprising a cellular modem coupled in communication with a cellular network for providing a first internet source.
A plurality of inlet/outlet ports, each port having a unique connector that includes or is associated with a nameplate for identifying the port's function.
A second distribution module comprising a second wireless communication device, wherein the second distribution module is coupled in wireless communication with the base station via the first and second wireless communication devices.
